(19) United States
(12) Patent Application Publication
(10) Pub. No.: US 2024/0236574 A9
(43) Pub. Date: Jul. 11, 2024

(54) FLAT PANEL TYPE VIBRATION DRIVER

(71) Applicant: Actuward. Co. Ltd., Suwon-si (KR)

(72) Inventor: Dong-Man KIM, Seoul (KR)

(21) Appl. No.: 17/769,504

(22) PCT Filed: Oct. 13, 2020
(86) PCT No.: PCT/KR2020/013902

§ 371 Date: Apr. 15, 2022

(30) Foreign Application Priority Data
Oct. 15, 2019 (KR) 10-2019-0127418

(51) Int. Cl. H04R 7/04; H04R 9/02; H04R 9/04; H04R 9/06

(52) U.S. Cl. CPC H04R 7/04; H04R 9/025; H04R 9/046; H04R 9/066

(57) ABSTRACT

A flat plate vibration driver according to an embodiment of the present invention includes a base frame; a vibration unit disposed inside the base frame and vibrating up and down by a magnetic circuit; and a suspension connecting the base frame and the vibration unit, and transmitting vertical vibrations of the vibration unit to the base frame, wherein the vibration unit further comprises: a pair of magnetic bodies; and a magnetic guide which is connected to both ends of the pair of magnetic bodies and the suspension, respectively, to maintain a separation distance between the magnetic bodies and float the magnetic bodies in the air at a predetermined position inside the base frame.

### TECHNICAL FIELD

The present invention relates to a flat plate vibration driver. More specifically, the present invention relates to a flat plate vibration driver implemented to transmit vertical vibration of an asymmetric magnetic body to a vibration object by using a magnetic guide connecting the asymmetric magnetic body and the suspension.

### BACKGROUND TECHNOLOGY

A vibration driver refers to a device for transmitting vibration to a vibration target.

Conventionally, a vibration driver wherein the diaphragm is removed from a so-called cone-type speaker device and either a circular magnet or a circular voice coil is directly attached to a vibrating object has been used.

In such a cone-type vibration driver, when the size of the vibration driver unit is large, in order to maintain the circular structure, the magnetic body becomes large in a circular shape, and there is a problem that the weight is increased. And, in such a cone-type vibration driver, there is a problem in that it is difficult to efficiently transmit vibration energy because the reaction speed is slow. In addition, since the bonding force of the bobbin itself is weak compared to its weight, there is a problem that the vibration driver falls off from the vibrating object after long-term use.

Korean Laid-Open Patent Publication No. 10-2019-0099775 discloses a ‘stick-type vibration driver’ that transmits vibration to a vibration target using a flat movable coil plate and a rod-type magnet.

According to Korean Laid-Open Patent Publication No. 10-2019-0099775, in order to overcome the disadvantages of the cone-type vibration driver, a rod-type magnet is applied. However, the size of the bar magnet was limited by the volume of the slim vibration driver. In addition, there is a disadvantage in that the size of the magnetic field is reduced thereby, so that sufficient magnetic field energy cannot be secured.

In order to overcome the shortcomings of the stick-type vibration driver, there is an attempt to apply a thick rod-type magnet. In this case, not only the weight but also the manufacturing cost is increased, and it is difficult to efficiently transmit the vibration energy. Accordingly, the same disadvantages as the cone-type vibration driver may occur.

Therefore, it is required to develop a vibration driver that is light in weight and can secure sufficient magnetic field energy while reducing manufacturing cost.

### PRIOR ART LITERATURE

(Patent Document 1) 1. Patent Document: Korean Laid-Open Patent Publication No. 10-2014-0136137 (2014.11.28)
(Patent Document 2) 2. Patent Document: Korean Laid-Open Patent Publication No. 10-2019-0099775

### DETAILED DESCRIPTION OF THE INVENTION

### Problem to be Solved

The present invention has been derived to solve the above problems. An object of the present invention is to realize a flat plate vibration driver with improved reaction speed by efficiently converting an induced electromotive force generated from an input signal and a magnetic field into vibration energy while reducing the volume and weight of the vibration driver.

### Technical Solution

A flat plate vibration driver according to an embodiment of the present invention includes a base frame; a vibration unit disposed inside the base frame and vibrating up and down by a magnetic circuit; and a suspension connecting the base frame and the vibration unit, and transmitting vertical vibrations of the vibration unit to the base frame, wherein the vibration unit further comprises: a pair of magnetic bodies; and a magnetic guide which is connected to both ends of the pair of magnetic bodies and the suspension, respectively, to maintain a separation distance between the magnetic bodies and float the magnetic bodies in the air at a predetermined position inside the base frame.

In addition, the base frame comprises an upper frame and a lower frame, the upper frame comprises an upper fixing part for fixing an upper part of a voice coil plate; and the lower frame comprises a lower fixing part for fixing a lower part of the voice coil plate.

The lower fixing part comprises: a through hole through which a lower portion of the voice coil plate protrudes by a predetermined length; and a fixing member which is inserted into the through hole to seal the base frame and fix the lower portion of the voice coil plate to the base frame.

In addition, the magnetic body comprises: magnets disposed side by side on both sides of the voice coil plate; and yokes disposed on upper and lower surfaces of the magnet; and the yoke comprises: a first yoke having a “-” shape in cross section and a second yoke having a “L” shape in cross section.

In addition, the magnetic guide comprises: a magnetic body fixing part; a suspension fixing part; and a jig guide part which is fixed to an assembly jig to guide the magnetic body fixing part to be fastened with the magnetic body, the suspension fixing part comprises: a seating surface which is recessed to seat the suspension; a bolt hole penetrated so as to be bolted to the suspension; and an anti-rotation guide which protrudes in a thickness direction of the suspension and penetrates the suspension to prevent rotation of the suspension.

Also, the seating surface may be disposed on a plane of the magnetic guide adjacent to the second yoke.

In addition, the second yoke includes a base portion in contact with the magnet; and a bent portion bent in a direction perpendicular to the base portion, the bent portion is positioned adjacent to a side portion of the voice coil plate, and an upper surface or a lower surface of the first yoke and a front end surface of the bent portion are placed on a same horizontal extension line.

In addition, the suspension may comprise a first suspension line; a center fixing part; and a second suspension line, in a W-shape.

In addition, the suspension consists of four, the center fixing parts of the two suspensions are positioned and fixed on a first line of the lower side of the vibration unit, and the center fixing parts of the other two suspensions are positioned and fixed on a second line of the upper side of the vibration unit.

In addition, a front ends of each of the first suspension line and the second suspension line are connected to the base frame, and the suspension is connected to the vibration unit at one position of the center fixing part.

In addition, the first suspension line is spaced apart from the vibration unit by a predetermined distance and is disposed horizontally with one surface of the vibration unit, and the second suspension line is spaced apart from the vibration unit by a predetermined distance and is disposed horizontally with one surface perpendicular to one surface of the vibration unit.

### Effects of the Invention

It is possible to reduce the production cost and weight of the vibration driver by reducing the volume of the magnet.

A large magnetic field can be generated compared to the volume of the magnet, so the volume of the vibration driver can be reduced.

Efficiency can be increased by reducing the weight of the vibration unit and increasing the reaction speed of the vibration driver even when inputting mid- and high-frequency signals.

The effects of the present invention are not limited to the above effects, and may be variously expanded without departing from the spirit and scope of the present invention.

### BRIEF DESCRIPTION OF DRAWINGS

FIG. 1 is a perspective view of a flat plate vibration driver according to an embodiment of the present invention. ((a) based on a plan view, (b) based on a bottom view)

FIG. 2 is an exploded perspective view of a flat plate type vibration driver according to an embodiment of the present invention.

FIG. 3 is a plan view (a) and A-A cross-sectional view (b) of an upper frame according to an embodiment of the present invention.

FIG. 4 is a bottom view (a) and a B-B cross-sectional view (b) of a flat plate vibration driver according to an embodiment of the present invention.

FIG. 5 is a bottom view of a flat plate vibration driver according to an embodiment of the present invention (lower frame not shown).

FIG. 6 is a perspective view (a) and a C-C cross-sectional view (b) of the vibration unit according to an embodiment of the present invention.

FIG. 7 is a perspective view (a), a plan view (b) and a side view (c) of a magnetic guide according to an embodiment of the present invention.

FIG. 8 is an exploded perspective view of a magnetic body according to an embodiment of the present invention.

FIG. 9 is a perspective view of a suspension according to an embodiment of the present invention.

### FORM FOR IMPLEMENTATION OF THE INVENTION

### Detailed Description of the Preferred Embodiments

The detailed description of the present invention set forth below refers to the accompanying drawings, which show by way of illustration specific embodiments in which the present invention may be practiced. These embodiments are described in sufficient detail to enable those skilled in the art to practice the present invention. It should be understood that the various embodiments of the present invention are different but need not be mutually exclusive. For example, certain shapes, structures, and characteristics described herein may be implemented in other embodiments without departing from the spirit and scope of the invention in relation to one embodiment. In addition, it should be understood that the location or arrangement of individual components within each disclosed embodiment may be changed without departing from the spirit and scope of the present invention. Accordingly, the following detailed description is not intended to be taken in a limiting sense, and the scope of the present invention, if properly described, is limited only by the appended claims, along with all scope equivalents to those as claimed. Like reference numerals in the drawings refer to the same or similar functions throughout the various aspects.

The detailed description of specific embodiments shown in the accompanying drawings is read in conjunction with the accompanying drawings, which are considered to be a part of the entire description of the invention. References to directions or directions are for convenience of description only, and are not intended to limit the scope of the present invention in any way.

Specifically, terms indicating a position such as “down, up, horizontal, vertical, upper, lower, upward, downward, upper, lower”, or derivatives thereof (eg, “horizontally, downwardly, upwardly”) etc.) should be understood with reference to both the drawings and related descriptions being described. In particular, since these relative words are only for convenience of description, it is not required that the device of the present invention be configured or operated in a specific direction.

In addition, terms indicating a mutual coupling relationship between components such as “mounted, attached, connected, connected, interconnected” refer to a state in which individual components are directly or indirectly attached, connected, or fixed, unless otherwise specified. can mean, and this should be understood as a term encompassing not only a movably attached, connected, fixed state, but also a non-movable state.

In adding reference numerals to the components of each drawing, it should be noted that the same components are given the same reference numerals as much as possible even though they are indicated on different drawings. In addition, in describing the present invention, if it is determined that a detailed description of a related known configuration or function may obscure the gist of the present invention, the detailed description thereof will be omitted.

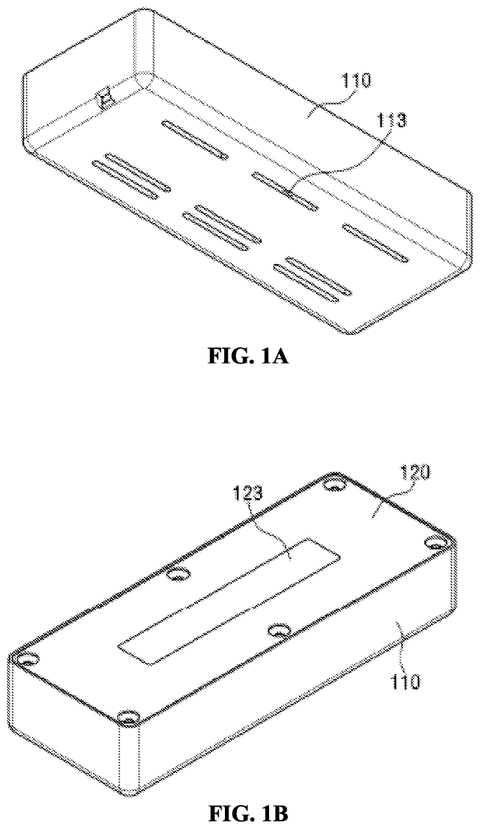

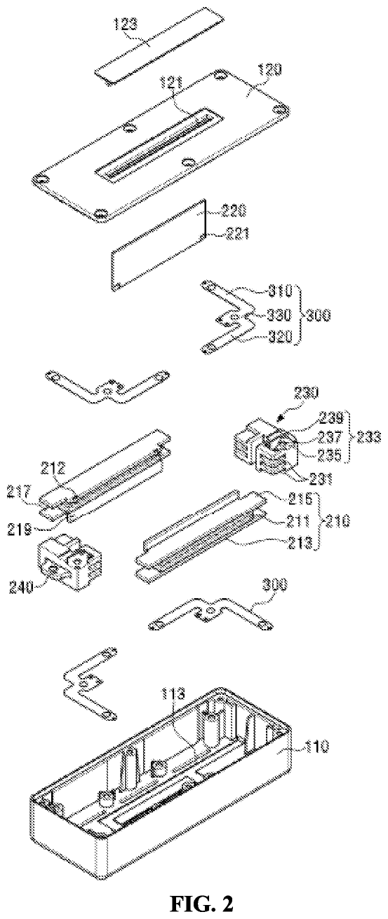

FIG. 1 is a perspective view of a flat plate type vibration driver according to an embodiment of the present invention ((a) based on a plan view, (b) based on a bottom view), and FIG. 2 is an exploded view of a flat plate type vibration driver according to an embodiment of the present invention.

Referring to FIG. 2, a flat plate vibration driver according to an embodiment of the present invention may include a base frame 100, a vibration unit 200, a suspension 300, and a voice coil plate 220.

The voice coil plate 220 may be vertically erected at the inner center of the base frame 100, that is, between the vibration unit 200.

A copper foil 221 is disposed on both sides of the lower end of the voice coil plate 220, and lead wires introduced from the outside are soldered to the copper foil 221, so that an electrical signal can be inputted from the outside.

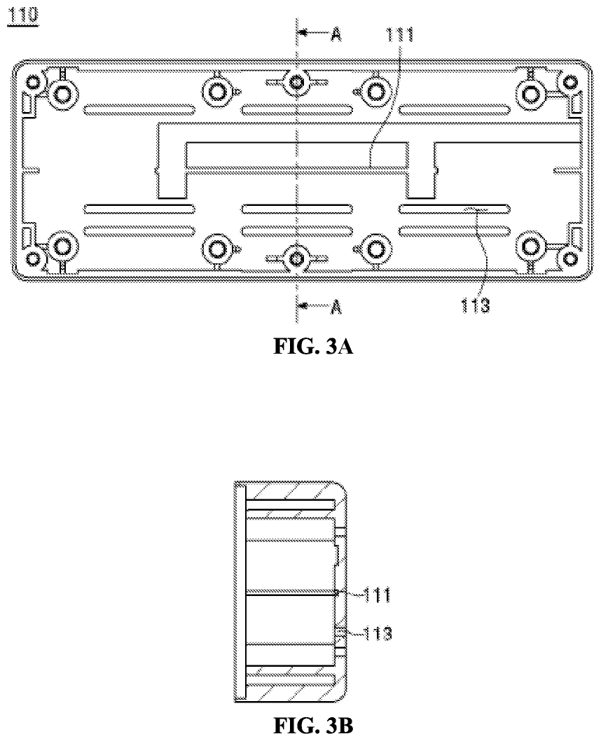

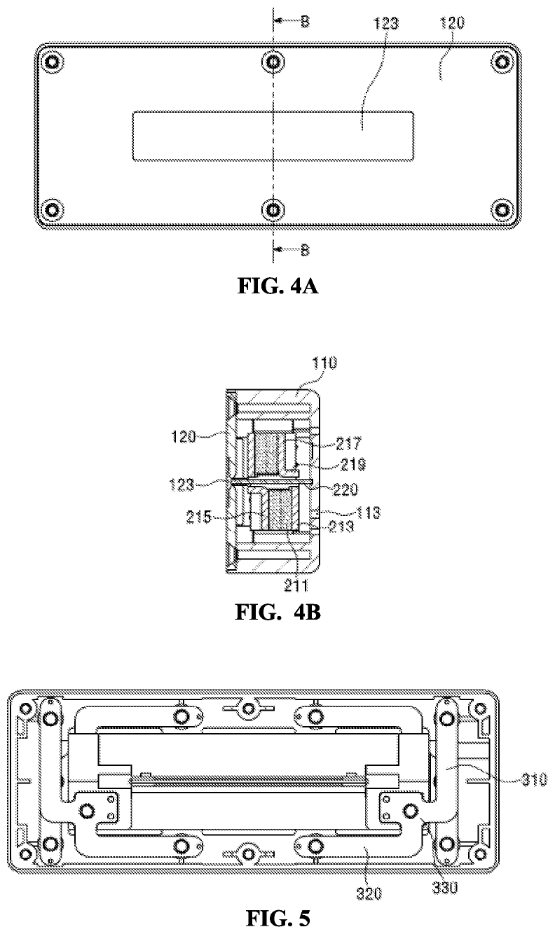

FIG. 3(a) is a plan view of the upper frame 110 according to an embodiment of the present invention, FIG. 3(b) is a cross-sectional view A-A. FIG. 4(a) is a bottom view of the flat plate type vibration driver according to an embodiment of the present invention, FIG. 4(b) is a cross-sectional view B-B.

Referring to FIGS. 1, 2 and 4, the base frame 100 may include an upper frame 110 and a lower frame 120.

Referring to FIG. 3, the upper frame 110 may include an upper fixing part 111 for fixing an upper portion of the voice coil plate 220 and a vent hole 113 for emitting heat inside the base frame 100.

Also, referring to FIG. 1(a), the upper frame 110 may include a lead wire through hole through which a lead wire soldered to the copper foil 221 of the voice coil plate 220 passes.

Referring to FIGS. 2 and 4, the lower frame 120 may include a lower fixing part for fixing the lower part of the voice coil plate 220.

The lower fixing part may include a through hole 121 through which the lower part of the voice coil plate 220 protrudes by a predetermined length, and a fixing member 123 which is inserted into the through hole 121 to seal the base frame 100 and fix the lower portion of the voice coil plate 220 to the base frame 100, that is, the lower frame 120.

Referring to FIG. 4(b), the upper part of the voice coil plate 220 is inserted into and fixed to the upper fixing part 111 of the upper frame 110. The lower portion of the voice coil plate 220 may be fixed to the lower frame 120 by inserting the fixing member 123 into the through hole 121 and being fixed to the lower frame 120 at the same time as being inserted into the fixing member 123.

In addition, the fixing member 123, the lower frame 120, and the lower portions of the voice coil plate 220 may be more firmly fixed through a bonding operation.

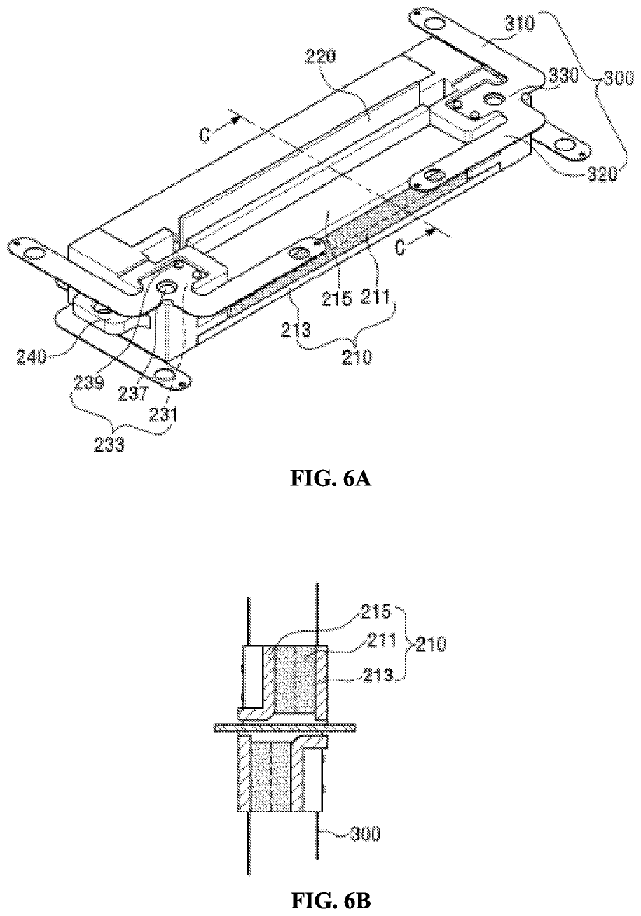

FIG. 5 is bottom view of a flat plate vibration driver according to an embodiment of the present invention. In order to show the internal configuration and fastening structure of the base frame 100, the lower frame 120 is not shown. FIG. 6(a) is a perspective view of the vibration unit 200 according to an embodiment of the present invention, FIG. 6(b) is a C-C sectional view.

As shown in FIG. 5, the vibration unit 200 is disposed inside the base frame 100 and may vibrate up and down by a magnetic circuit formed by the magnetic body 210.

Referring to FIGS. 5 and 6, the vibration unit 200 comprises a pair of magnetic bodies 210 and a magnetic guide 230 which is connected to both ends of the pair of magnetic bodies 210, and the suspension 300, respectively, to maintain a separation distance between the magnetic bodies 210 and float the magnetic bodies 210 in the air at a predetermined position inside the base frame 100.

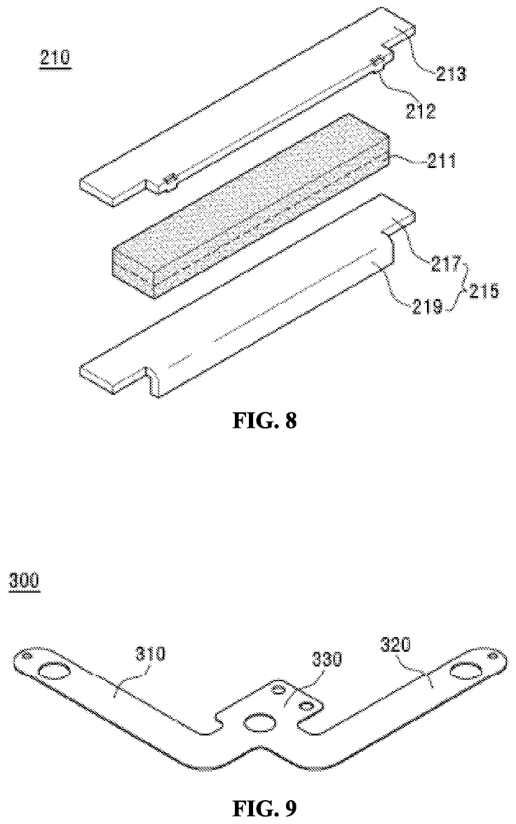

FIG. 8 is an exploded perspective view of the magnetic body 210 according to an embodiment of the present invention.

Referring to FIGS. 2, 6(b) and 8, the magnetic body 210 includes magnets 211 disposed side by side on both sides of the voice coil plate 220, and yokes to be disposed on upper and lower surfaces of the magnet 211.

The yokes may include a first yoke 213 having a “-” shape in cross section and a second yoke 215 having a “L” shape in cross section.

The first yoke 213 include at least one magnet fixing part 212 protruding to prevent contact between the magnets 211 by attractive force. The magnet fixing part 212 may be disposed on the side of the first yoke 213 adjacent to the side of the voice coil plate 220.

The second yoke 215 includes a base portion 217 in contact with the magnet 211 and a bent portion 219 bent in a direction perpendicular to the base portion 217. The bent portion 219 may be positioned adjacent to a side portion of the voice coil plate 220.

Referring to FIGS. 2, 4 (b), 6 (b) and 8, the bent portion 219 may be bent to a direction opposite to the magnet 211.

That is, when the second yoke 215 is positioned on the upper surface of the magnet 211, the bent portion 219 is bent upward, and the second yoke 215 is positioned on the lower surface of the magnet 211. The bent portion 219 may be bent in the downward direction.

Also, referring to FIGS. 4 (b) and 6(b), the upper or lower surface of the first yoke 213 and the front end surface of the bent portion 219 of the second yoke may be placed on the same horizontal extension line. The upper or lower surface of the first yoke 213 and the front end surface of the bent portion 219 of the second yoke 215 are placed on the same horizontal extension line, so that the magnets 211 on both sides around the voice coil plate 220 may be arranged in different vertical positions.

In addition, the first yoke 213 is disposed on the N pole surface or S pole surface of the magnet 211, and the second yoke 215 is disposed on the S pole surface or N pole surface of the magnet 211. The first yoke and the second yoke may be disposed so that polarities different from each other are opposite to each other.

Preferably, the first yoke 213 is disposed on the N-pole surface of the magnet 211, and the second yoke 215 is disposed on the S-pole surface of the magnet 211. The magnetic field starting from the first yoke 213 having a small area moves to the second yoke 215 having a large area. Thereby, it is possible to efficiently improve the circulation of the magnetic field.

In more detail, the magnetic field flows from the N pole to the S pole. The magnetic field originating from the N pole has the characteristic of sticking to the nearest S pole in terms of distance. Therefore, the magnetic field (in the present invention) starting from the first yoke 213 (N pole) having a smaller area compared to the second yoke 215 (S pole) is more strongly activated and can spread widely than a magnetic field flowing from the N pole to the S pole of the same area (as in the prior art).

This widely spread magnetic field is attached to the nearest S pole, that is, the second yoke 215 disposed on the opposite side with respect to the voice coil plate 220. The second yoke 215 widely receives the magnetic field transmitted from the first yoke 213 by using a large area of the bent portion 219. Accordingly, it is possible to smoothly circulate the magnetic field.

The yoke is disposed on the upper and lower surfaces of the magnet 211 and has the same polarity as the contacted portion of the magnet 211.

According to an embodiment of the present invention, by changing the cross section of the yoke, the same performance as using a magnet 211 which has an expanded size (thickness) of the corresponding pole can be expected.

That is, according to the present invention, it has the same performance as using a magnet 211 having an S pole or an N pole with a thickness added by the height of the bent portion 219 of the second yoke 215. However, the size of the magnet 211 actually used is small. Therefore, the manufacturing cost can be reduced. In addition, the weight of the vibration unit 200 can also be reduced. Accordingly, the response speed of the vibration unit 200 is increased even to the mid- and high-band input signals. Therefore, the efficiency of the vibration driver can be finally increased.

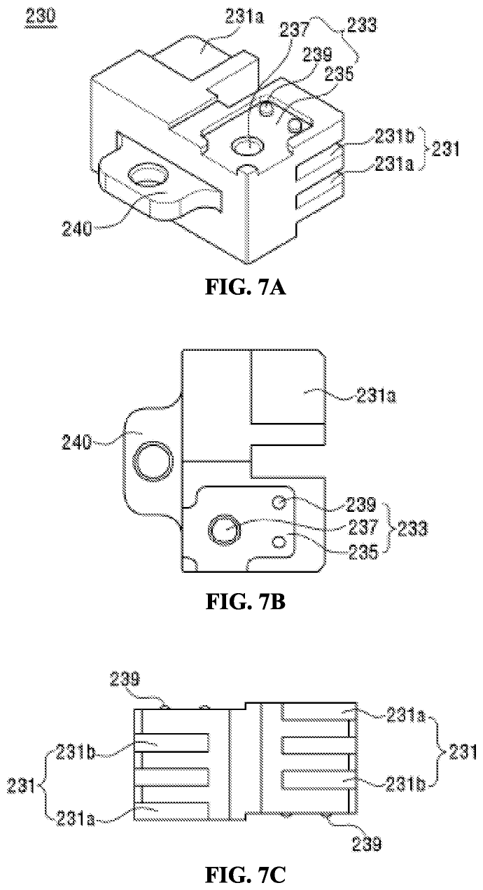

FIG. 7(a) is a perspective view of a magnetic guide 230 according to an embodiment of the present invention, FIG. 7(b) is a plan view of FIG. 7(a), and FIG. 7(c) is a side view of FIG. 7(a).

Referring to FIG. 7, the magnetic guide 230 comprises a magnetic body fixing part 231, a suspension fixing part 233, and a jig guide part 240.

The magnetic guide 230 is manufactured through injection molding. Thereby, the weight of the vibration unit 200 can be reduced.

By applying the magnetic guide 230 of the injection-molded plastic material and the yoke with a changed cross section, it is possible to reduce the weight of the vibration unit 200. And finally, it is possible to increase the vibration efficiency of the vibration drive.

The suspension fixing part 233 comprises a seating surface 235 which is recessed so that the suspension 300 is seated, a bolt hole 237 penetrated so as to be bolted to the suspension 300, and an anti-rotation guide 239 which is formed to protrude in the thickness direction of the suspension 300 and penetrate the suspension 300 for preventing rotation of the suspension 300.

The seating surface 235 is recessed to correspond to the shape of the center fixing part 330 of the suspension 300 to be described later. Accordingly, the seating surface 235 may be disposed on a plane of the magnetic guide 230 adjacent to the second yoke 215.

That is, with respect to the voice coil plate 220, the second yoke 215 may be disposed on an upper surface of one side of the magnetic guide 230 to which the magnetic body 210 positioned on an upper surface of the magnet 211 is fixed. And, the second yoke 215 may be disposed on the lower surface of the other side of the magnet guide 230 to which the magnet 210 positioned on the lower surface side of the magnet 211 is fixed.

At least one anti-rotation guide 239 may be disposed on the seating surface 235.

The anti-rotation guide 239 prevents the suspension 300 from rotating on the seating surface 235. In addition, by allowing the suspension 300 to be seated in a fixed position on the seating surface 235, it is possible to omit the cumbersome positioning process not only when the suspension 110 and the magnetic guide 230 are fastened but also when the suspension 300 and the upper frame 110 are fastened.

The magnetic body fixing part 231 includes a first fixing part 231a fixing one side of the first yoke 213 and a second fixing part 231b fixing one side of the base part 217 of the second yoke 215.

The jig guide part 240 is fixed to an assembly jig. The jig guide part 240 may guide such that the magnetic body fixing part 231 be fastened to the magnetic body 210.

The jig guide part 240 is formed to protrude in the opposite direction of the magnetic body 210. The jig guide part 240 may include a hole coupled to the assembling jig.

As the volume of the vibration driver, that is, the base frame 100, decreases, the volumes of the components of the vibration unit 200 also decrease. In particular, the magnetic guide 230 is a plastic material, and is not only light, but also has a small volume, an assembly jig may be used for assembly with the magnetic body 210.

In more detail, the assembly jig is inserted into the hole of the jig guide part 240 to fix the magnetic guide 230 in the height direction. By inserting the magnetic guide 230 fixed in the height direction in the horizontal direction, both ends of the first yoke 213 are disposed in the first fixing part 231a, and both ends of the base part 217 of the second yoke 215 are disposed in the second fixing part 231b. Thereby, the jig guide part 240 may guide the magnetic body guide 230 and the magnetic body 210 to be fastened at a fixed position.

As described above, a pair of magnetic bodies 210 are disposed so that different types of yokes face each other on the left and right with respect to the voice coil plate 220. Because of that, the magnetic body fixing part 231 may also be formed to be left and right asymmetrically to correspond thereto.

That is, with respect to the voice coil plate 220, the second fixing part 231b may be positioned at an upper side at a side of the magnetic guide 230 to which the magnetic body 210 where the second yoke 215 is located on the upper surface of the magnet 211 is fixed. The second fixing part 231b may be positioned at a lower side at a side of the magnetic guide 230 to which the magnetic body 210 where the second yoke 215 is located on the lower surface of the magnet is fixed.

FIG. 9 is a perspective view of a suspension 300 according to an embodiment of the present invention.

Referring to FIGS. 5 and 6, the suspension 300 may connect the base frame 100 and the vibration unit 200 and transmit vertical vibrations of the vibration unit 200 to the base frame 100.

Referring to FIG. 9, the suspension 300 may include a first suspension line 310, a center fixing part 330, and a second suspension line 320 in a W-shape.

The suspension 300 may be in the form of a thin plate made of a metal material having elasticity.

Referring to FIG. 5, each of the first suspension line 310, the center fixing part 330, and the second suspension line 320 may include a hole, a groove, or a protrusion corresponding to the structure and position of the counterpart.

Referring to FIG. 6(a), the suspension 300 is consist of four, the center fixing parts 330 of the two suspensions 300 are positioned and fixed on the first line of the lower side of the vibration unit 200, and, the center fixing part 330 of the other two suspensions 300 may be positioned and fixed on the second line of the upper side of the vibration unit 200.

Here, the first line may be on a plane of the lower side of the magnetic body 210 disposed on one side with the voice coil plate 220 as the center, that is, a plane spaced apart downward by a predetermined distance from the base portion 217 of the second yoke 215 located on the lower side of the magnet 211. The second line may be on a plane of the upper side of the magnetic body 210 disposed on the other side with the voice coil plate 220 as the center, that is, a plane spaced apart upward by a predetermined distance from the base portion 217 of the second yoke 215 located on the upper side of the magnet 211.

Referring to FIG. 5, the front end of each of the first suspension line 310 and the second suspension line 320 is connected to the base frame 100, that is, the upper frame 110. The suspension may be connected to the vibration unit 200 that is, the magnetic guide 230 at one position of the center fixing part 330.

In addition, the first suspension line 310 may be spaced apart from the vibration unit 200 by a predetermined distance, and may be disposed horizontally with one surface of the vibration unit 200. The second suspension line 320 may be spaced apart from the vibration unit 200 by a predetermined distance, and may be disposed horizontally with one surface perpendicular to one surface of the vibration unit 200.

The separation distance between the first suspension line 310 and the vibration unit 200 and between the second suspension line 320 and the vibration unit 200 may be a distance for avoiding collision with the suspension 300 due to torsion occurring during vertical vibration of the vibration unit 200.

The separation distance between the first suspension line 310 and the vibration unit 200 may be narrower than or equal to the separation distance between the second suspension line 320 and the vibration unit 200.

Features, structures, effects, etc. described in the above embodiments are included in one embodiment of the present invention, and are not necessarily limited to one embodiment. Furthermore, features, structures, effects, etc. illustrated in each embodiment can be combined or modified for other embodiments by a person skilled in the art to which the embodiments belong. Accordingly, the contents related to such combinations and modifications should be interpreted as being included in the scope of the present invention.

In addition, although the embodiment has been described above, it is merely an example and does not limit the present invention, and those of ordinary skill in the art to which the present invention pertains are exemplified above in a range that does not depart from the essential characteristics of the present embodiment. It can be seen that various modifications and applications that have not been made are possible.

For example, each component specifically shown in the embodiment can be implemented by modification. And differences related to such modifications and applications should be construed as being included in the scope of the present invention defined in the appended claims.

### EXPLANATION OF REFERENCE NUMERALS

100: base frame
200: vibration unit
300: suspension
110: upper frame
120: lower frame
210: magnetic body
220: voice coil plate
230: magnetic guide
240: jig guide unit
310; first suspension line
320: second suspension line
330: center fixing part
111: upper fixing part
113: vent hole
121: through hole
123: fixing member
211: magnet
212: magnet fixing part
213: first yoke
215: second yoke
217: base part
219: bent portion
221: copper foil
231: magnetic body fixing part
233: suspension fixing part
235: seating surface
237: bolt hole
239: anti-rotation guide
213a: first fixing part
231b: second fixing part

1. A flat plate vibration driver, comprising:
a base frame;
a vibration unit disposed inside the base frame and vibrating up and down by a magnetic circuit; and
a suspension connecting the base frame and the vibration unit, and transmitting vertical vibrations of the vibration unit to the base frame,
wherein
the vibration unit further comprises:
a pair of magnetic bodie; and
a magnetic guide which is connected to both ends of the pair of magnetic bodies and the suspension, respectively, to maintain a separation distance between the magnetic bodies and float the magnetic bodies in the air at a predetermined position inside the base frame.

2. The flat plate vibration driver of claim 1, wherein
the base frame comprises an upper frame and a lower frame,
the upper frame comprises an upper fixing part for fixing an upper part of a voice coil plate; and
the lower frame comprises a lower fixing part for fixing a lower part of the voice coil plate.

3. The flat plate vibration driver of claim 2, wherein
the lower fixing part comprises:
a through hole through which a lower portion of the voice coil plate protrudes by a predetermined length; and
a fixing member which is inserted into the through hole to seal the base frame and fix the lower portion of the voice coil plate to the base frame.

4. The flat plate vibration driver of claim 2, wherein
the magnetic body comprises:
magnets disposed side by side on both sides of the voice coil plate; and
yokes disposed on upper and lower surfaces of the magnet; and
the yoke comprises:
a first yoke having a “-” shape in cross section and
a second yoke having a “L” shape in cross section.

5. The flat plate vibration driver of claim 4, wherein
the magnetic guide comprises:
a magnetic body fixing part;
a suspension fixing part; and
a jig guide part which is fixed to an assembly jig to guide the magnetic body fixing part to be fastened with the magnetic body,
the suspension fixing part comprises:
a seating surface which is recessed to seat the suspension;
a bolt hole penetrated so as to be bolted to the suspension; and
an anti-rotation guide which protrudes in a thickness direction of the suspension and penetrates the suspension to prevent rotation of the suspension.

6. The flat plate vibration driver of claim 5, wherein
the seating surface is disposed on a plane of the magnetic guide adjacent to the second yoke.

7. The flat plate vibration driver of claim 4, wherein
the second yoke includes:
a base portion in contact with the magnet; and
a bent portion bent in a direction perpendicular to the base portion,
the bent portion is positioned adjacent to a side portion of the voice coil plate, and
an upper surface or a lower surface of the first yoke and a front end surface of the bent portion are placed on a same horizontal extension line.

8. The flat plate vibration driver of claim 1, wherein
the suspension comprises:
a first suspension line; a center fixing part; and a second suspension line, in a W-shape.

9. The flat plate vibration driver of claim 8, wherein
the suspension consists of four,
the center fixing parts of the two suspensions are positioned and fixed on a first line of the lower side of the vibration unit, and
the center fixing parts of the other two suspensions are positioned and fixed on a second line of the upper side of the vibration unit.

10. The flat plate vibration driver of claim 8, wherein
the front ends of each of the first suspension line and the second suspension line are connected to the base frame, and
the suspension is connected to the vibration unit at one position of the center fixing part.

11. The flat plate vibration driver of claim 8, wherein
the first suspension line is spaced apart from the vibration unit by a predetermined distance and is disposed horizontally with one surface of the vibration unit, and
the second suspension line is spaced apart from the vibration unit by a predetermined distance and is disposed horizontally with one surface perpendicular to one surface of the vibration unit.
